(19) United States
(12) Patent Application Publication
(10) Pub. No.: US 2026/0047671 A1
(43) Pub. Date: Feb. 19, 2026

(54) CLEANING BRUSH

(71) Applicant: Shenzhen Lute Jiacheng Supply Chain Management Co., Ltd., Shenzhen (CN)

(72) Inventors: Caihu Jia, Shenzhen (CN); Hengwei Wei, Shenzhen (CN); Jun Wang, Shenzhen (CN); Siyu Li, Shenzhen (CN); Qiao Yao, Shenzhen (CN)

(21) Appl. No.: 19/369,354

(22) Filed: Oct. 27, 2025

(30) Foreign Application Priority Data
Nov. 6, 2024 (CN) 202422710915.3

(51) Int. Cl. A46B 13/04; A46B 5/00; A46B 13/00; F16K 15/04

(52) U.S. Cl. CPC A46B 13/04; A46B 5/0095; A46B 13/001; A46B 2200/3006; F16K 15/04

(57) ABSTRACT

A cleaning brush includes a brush rod, a negative pressure assembly, a valve, and a liquid storage bottle. The brush rod includes a liquid outlet. The negative pressure assembly includes a pushing element and a negative pressure element. The negative pressure element defines a negative pressure channel. The pushing element defines a liquid inlet in communication with the liquid outlet. The pushing element is slidably arranged in the negative pressure channel, a pressure in the negative pressure channel is caused to change by a sliding of the pushing element. The liquid inlet is selectively in communication with the negative pressure channel. The negative pressure assembly is arranged in the liquid storage bottle, and the negative pressure channel is selectively in communication with the liquid storage bottle through the valve controlled by the pressure in the negative pressure channel.

### CROSS-REFERENCE TO RELATED APPLICATIONS

The present application claims priority of Chinese Patent Application No. 202422710915.3, filed on Nov. 6, 2024, the entire contents of which are hereby incorporated by reference.

### TECHNICAL FIELD

The present disclosure relates to the technical field of cleaning brushes, in particular to a cleaning brush.

### BACKGROUND

A cleaning brush is a tool primarily used for cleaning bottles. Existing cleaning brushes are categorized into manual and electric types. When using a manual cleaning brush, the cleaning solution should first be poured into the bottle by hand, which is very inconvenient during the actual cleaning process. Furthermore, due to the narrow bottle openings, the cleaning solution often cannot be poured smoothly into the bottle, significantly hindering the cleaning task. Electric cleaning brushes, on the other hand, are typically equipped with air pumps to spray the cleaning solution. However, the mechanical structure for electric liquid extraction is relatively complex, significantly increasing production costs and reducing economic viability. This also adds to the overall weight, diminishing the user experience.

### SUMMARY

In view of the deficiencies in the prior art, the present disclosure provides a cleaning brush, which is convenient for delivering cleaning solution into a bottle and preventing the cleaning solution from spilling.

In order to achieve the above purpose, the present disclosure adopts the following technical scheme:

A cleaning brush includes a brush rod, a negative pressure assembly, a valve, and a liquid storage bottle. The brush rod includes a liquid outlet. The negative pressure assembly includes a pushing element and a negative pressure element. The negative pressure element defines a negative pressure channel. The pushing element defines a liquid inlet in communication with the liquid outlet. The pushing element is slidably arranged in the negative pressure channel, a pressure in the negative pressure channel is caused to change by a sliding of the pushing element. The liquid inlet is selectively in communication with the negative pressure channel. The negative pressure assembly is arranged in the liquid storage bottle, and the negative pressure channel is selectively in communication with the liquid storage bottle through the valve controlled by the pressure in the negative pressure channel.

In one embodiment, the negative pressure assembly further includes an elastic element, the elastic element is arranged in the negative pressure element and elastically abuts between the pushing element and the negative pressure element.

In one embodiment, the negative pressure assembly further includes a blocking element, the blocking element is connected to an inner wall that defines the negative pressure channel, the liquid inlet is defined on a side of the pushing element; the negative pressure channel includes a first position and a second position, when the pushing element slides to the first position, the blocking element blocks the liquid inlet, and when the pushing element slides to the second position, the blocking element exposes the liquid inlet.

In one embodiment, the pushing element defines a limiting groove in communication with the liquid inlet, the blocking element is slidably arranged in the limiting groove; the pushing element includes a top portion and a bottom portion at opposite ends of the limiting groove along its length direction; when the pushing element slides to the first position, the blocking element abuts against the bottom portion; when the pushing element slides to the second position, the blocking element abuts against the top portion.

In one embodiment, the negative pressure channel includes a negative pressure port, the negative pressure port is in communication with the liquid storage bottle, and the valve is movably arranged at the negative pressure port.

In one embodiment, the negative pressure assembly further comprises a limiting part arranged at the negative pressure port, the limiting part is arranged at an interval with the valve configured for limiting the movement range of the valve.

In one embodiment, the negative pressure element includes an assembly part and a conical part, the assembly part defines the negative pressure channel, one end of the assembly part close to the negative pressure port is connected with the conical part, the conical part defines the negative pressure port, and along a direction away from the assembly part, the negative pressure port and the conical part are in a gradually tapering configuration.

In one embodiment, the liquid outlet is defined at a top and/or peripheral portion of the brush rod.

In one embodiment, the brush rod is detachably connected with the pushing element, and the cleaning brush further includes a main drive assembly; the main drive assembly is connected with the liquid storage bottle, or the main drive assembly is connected with the brush rod.

In one embodiment, a sliding direction of the pushing element is parallel with a length direction of the brush rod; or, a sliding direction of the pushing element is arranged at an angle with a length direction of the brush rod.

In one embodiment, when the pushing element is forced to slide to the second position by the brush rod, air in the negative pressure channel is squeezed to press liquid into the liquid inlet, when the pushing element is forced to slide to the first position, air pressure in the negative pressure channel decreases.

In one embodiment, the pushing element defines an internal channel, the negative pressure channel communicates with the liquid outlet through the internal channel.

The beneficial effects of the present disclosure are as follows: the embodiment of the present disclosure provides a cleaning brush, which includes a brush rod, a negative pressure assembly, a valve, and a liquid storage bottle. The brush rod includes a liquid outlet. The negative pressure assembly includes a pushing element and a negative pressure element. The negative pressure element defines a negative pressure channel. The pushing element defines a liquid inlet in communication with the liquid outlet. The pushing element is slidably arranged in the negative pressure channel, a pressure in the negative pressure channel is caused to change by a sliding of the pushing element. The liquid inlet is selectively in communication with the negative pressure channel. The negative pressure assembly is arranged in the liquid storage bottle, and the negative pressure channel is selectively in communication with the liquid storage bottle through the valve controlled by the pressure in the negative pressure channel. Compared with the prior art, the present disclosure realizes the spraying of cleaning solution or water through the reciprocating movement of the pushing element in the negative pressure channel, without using devices such as air pumps, thereby saving production costs, simplifying the design difficulty of the structure and reducing the overall weight, In addition, the liquid outlet is arranged on the brush rod, and as the brush rod extends into the bottle, the cleaning solution or water can be accurately and quickly sprayed to any part inside the bottle, effectively preventing the cleaning solution or water from spilling out of the bottle and improving the cleaning efficiency and cleaning effect.

### BRIEF DESCRIPTION OF DRAWINGS

To illustrate the technical solutions more clearly in the present disclosure or prior art, a brief description of the accompanying drawing to be used in the description of the embodiments or prior art will be given below. The drawings described below are obviously just embodiment/embodiments of the present disclosure. For ordinary technicians in this field, other drawings can be obtained based on the drawing without doing creative work.

FIG. 1 is a schematic view of the structure of a cleaning brush according to an embodiment of the present disclosure.

FIG. 2 is a schematic view of a cross-sectional of a cleaning brush according to an embodiment of the present disclosure.

FIG. 3 is a schematic view of a cross-sectional of a negative pressure assembly according to an embodiment of the present disclosure.

### REFERENCES

1. Brush rod; 11. Liquid outlet; 2. Negative pressure assembly; 21. Pushing element; 22. Negative pressure element; 23. Elastic element; 24. Blocking element; 25. Limiting part; 211. Liquid inlet; 212. Limiting groove; 221. Negative pressure channel; 222. Negative pressure port; 223. Assembly part; 224. Conical part; 2121. Top portion; 2122. Bottom portion; 3. Liquid storage bottle; 4. Valve; 5. Main drive assembly; 51. Shell; 52. Driving element; 53. Connecting element; 521. Driving shaft.

### DESCRIPTION OF EMBODIMENTS

In the present disclosure, the terms “arrange”, “be provided with” and “connect” should be understood in a broad sense. For example, they may refer to fixed connection, detachable connection, or integral structure; they may refer to mechanical connection or electrical connection; they may refer to direct connection, or indirect connection through an intermediate medium, or internal communication between two devices, elements, or components. For those of ordinary skill in the art, the specific meanings of the above terms in the present disclosure can be understood according to specific situations.

The terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “radial”, “circumferential” and the like indicate orientations or positional relationships based on the orientations or positional relationships shown in the drawings, which are only for the convenience of describing the present application and simplifying the description, rather than indicating or implying that the referred device or element must have a specific orientation, be constructed and operated in a specific orientation, and thus cannot be understood as a limitation to the present application.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present application, the meaning of “plurality” is at least two, such as two, three, etc., unless otherwise clearly and specifically defined.

Moreover, the above-mentioned partial terms may also be used to indicate other meanings besides orientation or positional relationship. For example, the term “upper” may also be used to indicate a certain attachment relationship or connection relationship in some cases. For those of ordinary skill in the art, the specific meanings of these terms in the present disclosure can be understood according to specific situations.

In order to make the purpose, technical scheme, and advantages of the present disclosure clearer, the present disclosure will be further described in detail below with reference to the drawings and embodiments. It should be understood that the specific embodiments described here are only used to explain the present disclosure, and are not used to limit the present disclosure.

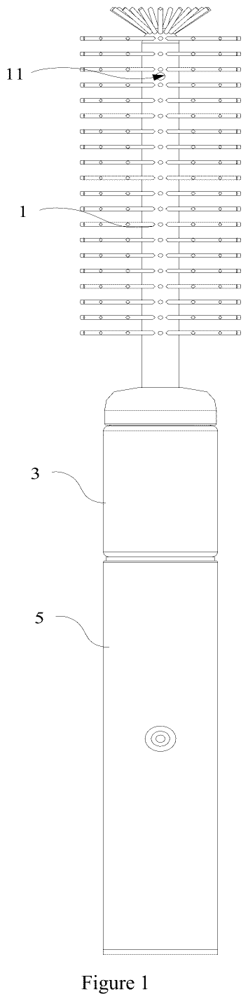

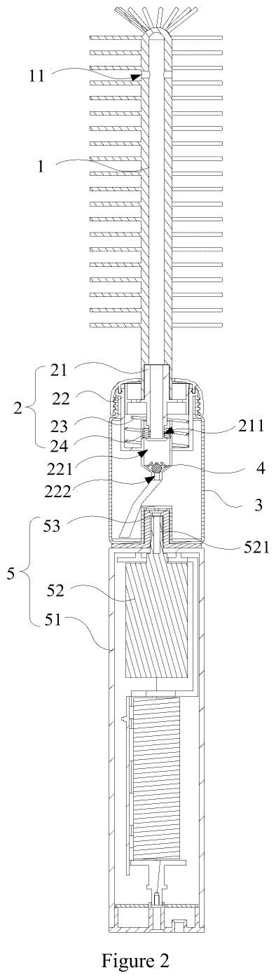

Referring to FIG. 1 and FIG. 2, an embodiment of the present disclosure provides a cleaning brush, which includes a brush rod 1, a negative pressure assembly 2, a liquid storage bottle 3, and a valve 4. The brush rod 1 is provided with a liquid outlet 11. The negative pressure assembly 2 includes a pushing element 21 and a negative pressure element 22. The negative pressure element 22 is provided with a negative pressure channel 221 and the pushing element 21 is provided with a liquid inlet 211. The liquid inlet 211 is in communication with the liquid outlet 11. The pushing element 21 is slidably arranged in the negative pressure channel 221, the sliding of the pushing element 21 causes pressure change in the negative pressure channel 221. The liquid inlet 211 is selectively in communication with the negative pressure channel 221. The negative pressure assembly 2 is arranged in the liquid storage bottle 3, and is selectively in communication with the liquid storage bottle 3 through the valve 4 controlled by the pressure in the negative pressure channel 221.

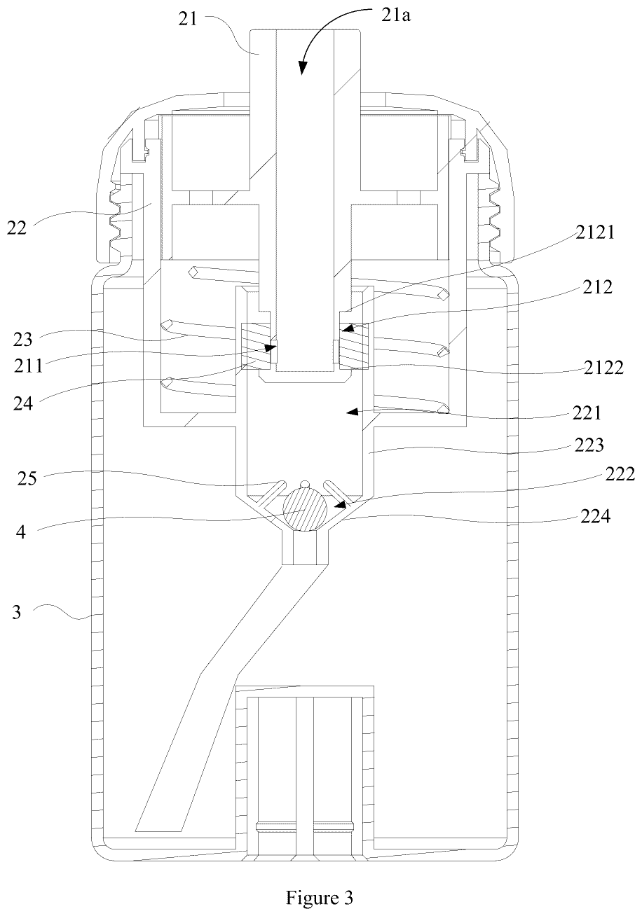

In practical application, the pushing element can be a rod, like a hollow pushing rod defining an internal channel 21a, as shown in the FIG. 3 as an example; the user slides the pushing element 21 in the negative pressure channel 221 to change the space occupied by the pushing element 21 in the negative pressure channel 221, thereby causing the air pressure in the negative pressure channel 221 to increase or decrease. Specifically, when the pushing element 21 slides to reduce the space connected with the negative pressure channel 221, the air pressure in the space is squeezed and the pressure increases. At this time, the liquid inlet 211 on the pushing element 21 is opened and connected with the negative pressure channel 221, and due to the high pressure in the negative pressure channel 221, the high air pressure will press the liquid in the negative pressure channel 221 (if there is liquid in the negative pressure channel 221) towards the liquid inlet 211. As the liquid inlet 211 is in communication with the liquid outlet 11 of the brush rod 1 through the internal channel 21a, the liquid can be sprayed out from the liquid outlet 11 of the brush rod 1 and enter various positions in the bottle along with the brush rod 1.

When the pushing element 21 slides to expand the space connected with the negative pressure channel 221, the air pressure in the space decreases. The external air pressure then “pushes” the valve 4 open, so that the negative pressure channel 221 is in communication with the liquid storage bottle 3, and the liquid in the liquid storage bottle 3 is “adsorbed” into the negative pressure channel 221. Thus, the liquid in the negative pressure channel 221 can be pressed to the liquid inlet 211 in the next sliding process of the pushing element 21, and then the liquid is sprayed out from the liquid outlet 11 of the brush rod 1. Through such circulation, the liquid in the liquid storage bottle 3 can be continuously introduced into the negative pressure channel 221, then guided from the negative pressure channel 221 to the brush rod 1, and finally sprayed into the bottle from the liquid outlet 11. It should be noted that the liquid in the liquid storage bottle 3 can be cleaning solution, water, or other liquids.

Compared with the prior art, the present disclosure realizes the spraying of cleaning solution or water through the reciprocating movement of the pushing element 21 in the negative pressure channel 221, without using devices such as air pumps, thereby saving production costs, simplifying the design difficulty of the structure, and reducing the overall weight. In addition, the liquid outlet 11 is arranged on the brush rod 1, and as the brush rod 1 extends into the bottle, the cleaning solution or water can be accurately and quickly sprayed to any part inside the bottle, effectively preventing the cleaning solution or water from spilling out of the bottle and improving the cleaning efficiency and cleaning effect.

In one embodiment, as shown in FIG. 2, the specific description is given by taking the case that the sliding direction of the pushing element 21 is substantially parallel to the length direction of the brush rod 1 as an example.

The brush rod 1 can be connected with the pushing element 21, and the user can push the brush rod 1 to push the pushing element 21 to move in the negative pressure channel 221, so as to realize the air pressure change in the negative pressure channel 221.

Specifically, along the length direction of the brush rod 1, when the user pushes the brush rod 1 to move downward (towards the liquid storage bottle 3), the brush rod 1 pushes the pushing element 21 to move downward, the air in the negative pressure channel 221 is squeezed, and the pressure thus increases. After the pushing element 21 moves downward for a certain distance, the liquid inlet 211 of the pushing element 21 is exposed, and the liquid in the negative pressure channel 221 will be pressed towards the liquid outlet 11 of the brush rod 1, entering the liquid inlet 211, and further sprayed into the bottle from the liquid outlet 11 through the internal channel 21a. Along the length direction of the brush rod 1, when the user pushes the brush rod 1 to move upward (away from the liquid storage bottle 3), the brush rod 1 pulls the pushing element 21 to move upward, the air pressure in the negative pressure channel 221 decreases, the valve 4 is thus opened. The negative pressure channel 221 is in communication with the liquid storage bottle 3, and the liquid in the liquid storage bottle 3 is pressed into the negative pressure channel 221, so that the negative pressure channel 221 stores part of the liquid for being pressed into the liquid inlet 211 next time. By adopting this structure, the user only needs to push pull the brush rod 1 to realize the reciprocating movement of the pushing element 21, and there is no need to design other structures to force the pushing element 21 to move, so the structure is simpler.

It should be noted that the above-mentioned up and down movement of the pushing element 21 does not refer to the movement in a specific direction. The downward movement of the pushing element 21 here refers to the direction in which the air inside the negative pressure channel 221 is squeezed to increase the air pressure in the negative pressure channel 221; the upward movement of the pushing element 21 refers to the direction in which the space connected with the negative pressure channel 221 by the pushing element 21 is expanded to reduce the air pressure in the negative pressure channel 221. When the direction of the pushing element 21 is not parallel to the length direction of the brush rod 1, the sliding direction of the pushing element 21 is not up and down movement either.

Referring to FIG. 2, the liquid outlet 11 can be defined at the top or the peripheral part of the brush rod 1, or the liquid outlet 11 can be opened at both the top and the peripheral part of the brush rod 1. As the liquid outlet 11 is defined at different positions of the brush rod 1, the brush rod 1 sprays the cleaning solution from different liquid outlets 11 to different parts in the bottle, so as to improve the cleaning effect. For example, the liquid outlet 11 at the top can conveniently spray the cleaning solution to the bottom of the bottle, and the cleaning solution at the peripheral part can conveniently spray the cleaning solution to the bottle body.

Referring to FIG. 2 and FIG. 3, the negative pressure assembly 2 further includes an elastic element 23, and the elastic element 23 is arranged in the negative pressure element 22 and elastically abuts between the pushing element 21 and the negative pressure element 22 respectively.

In practical application, the elastic element 23 is mainly used to assist the reset of the pushing element 21. When the user pushes the pushing element 21 to move in a certain direction, the pushing element 21 causes the elastic element 23 to undergo elastic deformation. When the user releases his hand or removes the force, the elastic element 23 pushes the pushing element 21 back to the initial position through the accumulated elastic potential energy, so as to realize the automatic reset function of the pushing element 21, make the reciprocating movement of the pushing element 21 in the negative pressure channel 221 faster, and save the user's physical strength. The elastic element 23 can adopt a structure such as a spring.

Referring to FIG. 3, the negative pressure assembly 2 includes a blocking element 24, the blocking element 24 is connected to the inner wall of the negative pressure element 22 that defines the negative pressure channel 221. The liquid inlet 211 is defined on the side of the pushing element 21. The negative pressure channel 221 has a first position and a second position. When the pushing element 21 slides to the first position, the blocking element 24 blocks the liquid inlet 211, and when the pushing element 21 slides to the second position, the blocking element 24 exposes the liquid inlet 211.

In practical application, the blocking element 24 is used to block the liquid inlet 211, so that the negative pressure channel 221 forms a relatively sealed environment. Specifically, any position between the initial position of the pushing element 21 and the position where the liquid inlet 211 of the pushing element 21 is about to be opened can be set as the first position. When the pushing element 21 moves within this distance, the blocking element 24 always blocks the liquid inlet 211, and the negative pressure channel 221 is a sealed space at this time. Therefore, the sliding of the pushing element 21 to squeeze the negative pressure channel 221 can increase the air pressure in the negative pressure channel 221 until the pushing element 21 slides to the second position, the blocking element 24 no longer blocks the liquid inlet 211, the liquid inlet 211 is in communication with the negative pressure channel 221, and the liquid in the negative pressure channel 221 enters the liquid inlet 211 and is sprayed into the bottle from the liquid outlet 11 of the brush rod 1. The arrangement of the blocking element 24 can make the negative pressure channel 221 form a sealed space, so that when the pushing element 21 squeezes the air inside the negative pressure channel 221, a high-pressure environment is formed in the negative pressure channel 221 to press the liquid into the liquid inlet 211.

It is understandable that even in the absence of the blocking member 24, the rapid movement of the pushing element 21 can still bring about changes in the air pressure inside the negative pressure channel 221. This pressure variation, in turn, generates a driving force that compels the liquid to flow. Specifically, when the pushing element 21 moves rapidly in a direction that reduces the internal space of the negative pressure channel 221, the air within the channel is compressed, leading to a sudden increase in pressure. This elevated pressure acts directly on the liquid present in the channel, pushing it toward the liquid inlet 211 of the pushing element 21 and further guiding it to the liquid outlet 11 of the brush rod 1 for spraying. Conversely, when the pushing element 21 moves rapidly in the opposite direction to expand the internal space of the negative pressure channel 221, the pressure inside the channel drops sharply. Under the effect of external atmospheric pressure, the liquid stored in the liquid storage bottle 3 is pushed open the valve 4 and drawn into the negative pressure channel 221, replenishing the liquid required for the next spraying cycle. Although the absence of the blocking member 24 means the negative pressure channel 221 cannot form a fully sealed space during the pushing element's movement, potentially resulting in minor pressure leakage and slightly reduced efficiency in liquid propulsion, the core mechanism of using pressure differences to drive liquid flow remains effective, ensuring the basic liquid-spraying function of the cleaning brush can still be realized.

Referring to FIG. 3, the pushing element 21 is further provided with a limiting groove 212 in communication with the liquid inlet 211. The blocking element 24 is slidably arranged in the limiting groove 212. The pushing element 21 has a top portion 2121 and a bottom portion 2122 at opposite ends of the limiting groove 212 along its length direction. When the pushing element 21 slides to the first position, the blocking element 24 abuts against the bottom portion 2122; when the pushing element 21 slides to the second position, the blocking element 24 abuts against the top portion 2121.

In practical application, the blocking element 24 can be movably connected to the inner wall of the negative pressure element 22 that defines the negative pressure channel 221. For example, the blocking element 24 abuts between the pushing element 21 and the negative pressure channel 221. When the pushing element 21 slides at the first position, since the blocking element 24 abuts against the side wall of the negative pressure channel 221, there is a large friction force between the blocking element 24 and the negative pressure channel 221. Therefore, when the pushing element 21 moves at the first position, the blocking element 24 does not move, so the pushing element 21 and the blocking element 24 move relatively, so that the blocking element 24 no longer blocks the liquid inlet 211, and the liquid inlet 211 is exposed. When the pushing element 21 moves to the second position, that is, when the top portion 2121 of the limiting groove 212 abuts against the blocking element 24, the pushing element 21 continues to move downward (towards the liquid storage bottle 3), and drives the blocking element 24 to move together. Thus, when the user releases his hand or removes the force, under the action of the elastic element 23, the pushing element 21 moves upward (away from the liquid storage bottle 3). Currently, due to the friction force between the blocking element 24 and the negative pressure channel 221, the pushing element 21 and the blocking element 24 move relatively again, so that the blocking element 24 blocks the liquid inlet 211 again until the bottom portion 2122 of the limiting groove 212 abuts against the blocking element 24, thereby driving the blocking element 24 to move upward until the pushing element 21 and the blocking element 24 return to their original positions.

With this configuration, when cleaning solution enters liquid inlet 211, the blocking element 24 can rapidly seal the liquid inlet 211 as soon as the user releases pressure or force, without waiting for the pushing element 21 to return to its original position. This ensures that the volume of fluid entering liquid inlet 211 at any given time remains limited, enabling the dispensing of cleaning fluid in small, multiple increments. This approach effectively conserves cleaning fluid consumption.

It can be understood that the blocking element 24 can be made of soft rubber material.

Referring to FIG. 3, the negative pressure channel 221 has a negative pressure port 222, the negative pressure port 222 is in communication with the liquid storage bottle 3, for example, through a conduit, and the valve 4 is movably arranged at the negative pressure port 222. In practical application, the valve 4 can adopt a valve ball, which is placed at the negative pressure port 222. When the pushing element 21 moves upward and the air pressure in the negative pressure channel 221 decreases, the air pressure inside the negative pressure channel 221 is low and the external air pressure is high, so the air in the conduit is squeezed into the negative pressure channel 221. The valve ball is thus pushed open to expose the negative pressure port 222, the negative pressure channel 221 is in communication with the liquid storage bottle 3, and the liquid in the liquid storage bottle 3 is also squeezed into the negative pressure channel 221. When the air pressure inside and outside the negative pressure channel 221 is equal, the valve ball blocks the negative pressure port 222 again under the action of gravity to seal the negative pressure channel 221.

Referring to FIG. 3, the negative pressure assembly 2 further includes a limiting part 25 arranged at the negative pressure port 222, the limiting part 25 is arranged at an interval with the valve 4, and the limiting part 25 is used for limiting the movement range of the valve 4.

In practical application, in order to prevent the valve ball from being pushed away from the negative pressure port 222 by a large distance under the action of air pressure, the present disclosure is provided with the limiting part 25. On one hand, the limiting part 25 provides a space for the valve ball to move, and on the other hand, it limits the movement range of the valve ball, so that the valve ball can only move near the negative pressure port 222. With such arrangement, the valve ball can not only expose the negative pressure port 222 to communicate the negative pressure channel 221 to the liquid storage bottle 3, but also block the flow of cleaning solution into the negative pressure port 222, so as to prevent the excessive liquid inflow of the negative pressure port 222, which leads to more liquid stored in the negative pressure channel 221 and affects the next sliding of the pushing element 21. At the same time, it is convenient for the valve ball to return to the initial position accurately under the action of gravity, so as to avoid affecting the sealing of the negative pressure channel 221.

Referring to FIG. 3, the negative pressure element 22 includes an assembly part 223 and a conical part 224. The assembly part 223 is provided with the negative pressure channel 221, one end of the assembly part 223 close to the negative pressure port 222 is connected with the conical part 224, the conical part 224 is provided with the negative pressure port 222. Along the direction away from the assembly part 223, the negative pressure port 222 and the conical part 224 are in a gradually tapering configuration.

In practical application, the gradually tapering configuration of the conical part 224 is beneficial to connection with the conduit and plays a guiding role. The gradually tapering configuration of the negative pressure port 222 can make the cross-sectional area of the negative pressure port 222 change gradually. When the fluid passes through the area with gradually reduced cross-sectional area, the flow rate will increase. This helps to improve the efficiency of negative pressure suction and can suck the liquid into the negative pressure channel 221 more quickly.

Referring to FIG. 2, the cleaning brush further includes a main drive assembly 5, and the main drive assembly 5 can be directly connected with the liquid storage bottle 3 to drive the liquid storage bottle 3 to rotate, thereby driving the brush rod 1 to rotate.

Specifically, the main drive assembly 5 includes a shell 51, a driving element 52 and a connecting element 53. The driving element 52 is installed in the shell 51, a driving shaft 521 of the driving element 52 extends out of the shell 51 and is connected with the connecting element 53. The connecting element 53 is used for detachably connecting with the liquid storage bottle 3, such as clamping, plugging or threaded connection. When it is necessary to spray the cleaning solution, the liquid storage bottle 3 is installed on the driving shaft 521, and then the brush rod 1 is connected with the pushing element 21. When the driving element 52 drives the liquid storage bottle 3 to rotate, the liquid storage bottle 3 drives the brush rod 1 to rotate, so as to realize the function of electric cleaning, improve the cleaning efficiency and save the user's physical strength.

The main drive assembly 5 can also be directly connected with the brush rod 1, and the brush rod 1 is detachably connected with the pushing element 21. When it is not necessary to spray the cleaning solution, the brush rod 1 can be separated from the pushing element 21, the liquid storage bottle 3 can be removed, and the brush rod 1 can be directly connected with the connecting element 53. The driving element 52 can directly drive the brush rod 1 to rotate, so as to realize the function of electric bottle brushing. With such arrangement, the force of the driving element 52 driving the brush rod 1 to rotate is greater, and the brush rod 1 can clean more thoroughly, which is beneficial to cleaning the stains tightly attached inside the bottle and improving the cleaning effect.

It can be understood that the brush rod 1 and the pushing element 21 can be detachably connected by means of plugging, clamping and the like.

It should be noted that in another embodiment, the sliding direction of the pushing element 21 can also be arranged at an angle with the length direction of the brush rod 1, for example, the sliding direction of the pushing element 21 is perpendicular to the length direction of the brush rod 1. A press switch can be arranged on the liquid storage bottle 3, and the press switch is connected with the pushing element 21. When the user holds the cleaning brush, he presses or releases the press switch with their finger, and the press switch drives the pushing element 21 to move, so as to realize the reciprocating movement of the pushing element 21 in the negative pressure channel 221, cause the pressure change in the negative pressure channel 221, and further realize the function of spraying the cleaning solution from the brush rod 1. By adopting this way, the press switch is arranged at the user's hand, which is more convenient to operate. The user can rotate the brush rod 1 to brush the bottle while pressing the press switch to spray the liquid, so as to improve the convenience of the cleaning brush. The present disclosure does not limit the sliding direction and sliding structure of the pushing element 21.

Different from the prior art, the embodiment of the present disclosure provides a cleaning brush, which includes a brush rod 1, a negative pressure assembly 2, a liquid storage bottle 3, and a valve 4. The brush rod 1 is provided with a liquid outlet 11; the negative pressure assembly 2 includes a pushing element 21 and a negative pressure element 22, the negative pressure element 22 is provided with a negative pressure channel 221, the pushing element 21 is provided with a liquid inlet 211, the liquid inlet 211 is in communication with the liquid outlet 11, the pushing element 21 is slidably arranged in the negative pressure channel 221, the sliding of the pushing element 21 causes pressure change in the negative pressure channel 221, and the liquid inlet 211 can be selectively in communication with the negative pressure channel 221; the negative pressure assembly 2 is arranged in the liquid storage bottle 3, and the negative pressure channel 221 can be selectively in communication with the liquid storage bottle 3 through the valve 4 controlled by the pressure in the negative pressure channel 221. Compared with the prior art, the present disclosure realizes the spraying of cleaning solution or water through the reciprocating movement of the pushing element 21 in the negative pressure channel 221, without using devices such as air pumps, thereby saving production costs, simplifying the design difficulty of the structure and reducing the overall weight; in addition, the liquid outlet 11 is arranged on the brush rod 1, and as the brush rod 1 extends into the bottle, the cleaning solution or water can be accurately and quickly sprayed to any part inside the bottle, effectively preventing the cleaning solution or water from spilling out of the bottle and improving the cleaning efficiency and cleaning effect.

The above are only specific implementation modes of the present application. It should be pointed out that for those of ordinary skill in the technical field, several improvements and modifications can be made without departing from the principle of the present application, and these improvements and modifications should also be regarded as the protection scope of the present application.

What is claimed is:

1. A cleaning brush, comprising:
a brush rod (1), comprising a liquid outlet (11);
a negative pressure assembly (2), comprising a pushing element (21) and a negative pressure element (22), wherein the negative pressure element (22) defines a negative pressure channel (221), the pushing element (21) defines a liquid inlet (211), the liquid inlet (211) is in communication with the liquid outlet (11), the pushing element (21) is slidably arranged in the negative pressure channel (221), a pressure in the negative pressure channel (221) is caused to change by a sliding of the pushing element (21), and the liquid inlet (211) is selectively in communication with the negative pressure channel (221);
a valve (4), controlled by the pressure in the negative pressure channel (221);
a liquid storage bottle (3), wherein the negative pressure assembly (2) is arranged in the liquid storage bottle (3), and the negative pressure channel (221) is selectively in communication with the liquid storage bottle (3) through the valve (4).

2. The cleaning brush according to claim 1, wherein the negative pressure assembly (2) further comprises an elastic element (23), the elastic element (23) is arranged in the negative pressure element (22) and elastically abuts between the pushing element (21) and the negative pressure element (22).

3. The cleaning brush according to claim 1, wherein the negative pressure assembly (2) further comprises a blocking element (24), the blocking element (24) is connected to an inner wall that defines the negative pressure channel (221), the liquid inlet (211) is defined on a side of the pushing element (21); the negative pressure channel (221) comprises a first position and a second position, when the pushing element (21) slides to the first position, the blocking element (24) blocks the liquid inlet (211), and when the pushing element (21) slides to the second position, the blocking element (24) exposes the liquid inlet (211).

4. The cleaning brush according to claim 3, wherein the pushing element (21) defines a limiting groove (212) in communication with the liquid inlet (211), the blocking element (24) is slidably arranged in the limiting groove (212); the pushing element (21) comprises a top portion (2121) and a bottom portion (2122) at opposite ends of the limiting groove (212) along its length direction; when the pushing element (21) slides to the first position, the blocking element (24) abuts against the bottom portion (2122); when the pushing element (21) slides to the second position, the blocking element (24) abuts against the top portion (2121).

5. The cleaning brush according to claim 1, wherein the negative pressure channel (221) comprises a negative pressure port (222), the negative pressure port (222) is in communication with the liquid storage bottle (3), and the valve (4) is movably arranged at the negative pressure port (222).

6. The cleaning brush according to claim 5, wherein the negative pressure assembly (2) further comprises a limiting part (25) arranged at the negative pressure port (222), the limiting part (25) is arranged at an interval with the valve (4) configured for limiting a movement range of the valve (4).

7. The cleaning brush according to claim 5, wherein the negative pressure element (22) comprises an assembly part (223) and a conical part (224), the assembly part (223) defines the negative pressure channel (221), one end of the assembly part (223) close to the negative pressure port (222) is connected with the conical part (224), the conical part (224) defines the negative pressure port (222), and along a direction away from the assembly part (223), the negative pressure port (222) and the conical part (224) are in a gradually tapering configuration.

8. The cleaning brush according to claim 1, wherein the liquid outlet (11) is defined at a top and/or peripheral portion of the brush rod (1).

9. The cleaning brush according to claim 1, wherein the brush rod (1) is detachably connected with the pushing element (21), the cleaning brush further comprises a main drive assembly (5); the main drive assembly (5) is connected with the liquid storage bottle (3), or the main drive assembly (5) is connected with the brush rod (1).

10. The cleaning brush according to claim 1, wherein a sliding direction of the pushing element (21) is substantially parallel with a length direction of the brush rod (1); or, a sliding direction of the pushing element (21) is arranged at an angle with a length direction of the brush rod (1).

11. The cleaning brush according to claim 3, wherein when the pushing element (21) is forced to slide to the second position by the brush rod (1), air in the negative pressure channel (221) is squeezed to press liquid into the liquid inlet (211), when the pushing element (21) is forced to slide to the first position, air pressure in the negative pressure channel (221) decreases.

12. The cleaning brush according to claim 1, wherein the pushing element defines an internal channel (21a), the negative pressure channel (221) communicates with the liquid outlet (11) through the internal channel (21a).
